(19) United States
(12) Patent Application Publication
(10) Pub. No.: US 2009/0125404 A1
(43) Pub. Date: May 14, 2009

(54) Interactive electronic menu system supported by dynamic software package

(76) Inventors: Samuel Sami Mekonen, Eiudhoven (NL); Abeba Abraham, Washington, DC (US); Samson Mengistu, East Brunswick, NJ (US)

Correspondence Address: Abeba Abraham, 2236 S Street, N.E., Washington, DC, 20002, US

(21) Appl. No.: 11/983,811

(22) Filed: Nov. 13, 2007

(51) Int. Cl. G06Q 50/00; G06Q 90/00

(52) U.S. Cl. 705/15

(57) ABSTRACT

A software supported dynamic interactive electronic menu system for restaurant/bar and coffee shop related businesses which is intended to replace traditional paper menus is hereby invented. This programmable lightweight menu provides customers with graphic view of menu items on the available screen to simplify the process of placing their orders. Complete information about restaurant food items can save time and avoid possible misunderstanding between waiters/waitresses and customers. It can also assist customers with information about other products within and/or out of the business in question depending on the circumstances.

### TECHNICAL FIELD

The invention relates to interactive menu capable of graphically displaying and describing menu items and associated side services of restaurant/bar and coffee-shop oriented businesses.

### BACKGROUND ART

Traditional paper menus have long been the global standard of communication between food and beverage businesses and their customers. Although some menus may display consumption products in single pictorial form and provide their brief description, they may still fall short of giving detailed information of what customers may individually select to consume, without at least the involvement of waiters/waitresses for further clarification. The direct communication as effective back-up support force to the prior art menus certainly improves the situation in question but may not be a complete solution to the associated drawbacks because the efficiency of waiters depends on their professional quality, their mood, memory, state of mind, attitude, interest, training, and their immediate physical and emotional conditions. In fact, it may sometimes becomes necessary for manager to answers some of customers' questions.

Other difficulty associated with paper menus is lack of linguistic flexibility. A menu written in English, for example remains to be ineffective to people who do not read and understand English. That necessitates a translator to serve such customers. But businesses may not be equipped with such convenience and they as well as the customers may suffer as a result. Besides improving the problems discussed above, this menu system is also ideal for effective use by hearing impaired customers. No more do they have to go through difficult times to place an order for they can easily take advantage of its interactive nature without any server assistance so long as they can read.

In view of the above problems associated with paper menus, it is the object of this computerized electronic menu system to fully inform customers about what they may order in food and beverage businesses by graphically displaying main dishes, associated side orders, refreshments and beverages on its screen in response to their input.

It is further the object of this invention to solve the problems associated with paper menus by providing interactive menu systems that can display detailed written information about all of the above including cooking style alternatives, applicable spices, coffee products, refreshments, alcoholic beverages and pastries.

It is further the object of this invention to provide linguistic flexibility for improved customer service by providing customers including those hearing impaired the possibility of communicating with the system in their languages of convenience.

It is further the object of this invention to provide dynamic software that can allow businesses to modify and amend their menus whenever necessary.

It is further the object of this invention to provide a space in the display region for possible advertisement of any product from interested enterprises.

### SUMMARY OF THE INVENTION

The interactive menu system comprises a display screen and touch screen input means to provide complete information about food items in restaurant businesses, coffee varieties in coffee shop businesses, locally made and internationally known beverages and refreshments, and pastry products in all-inclusive dedicated business enterprises.

Not only does the invention avoid the need of servers in food and beverage oriented customer service facilities, but it also provides customers with the capacity of modifying their orders by directly accessing the material compositions of their selections, thereby maximizing their satisfaction and conserving processing time. Furthermore, this capacity allows customers to be aware of everything in their selected food, coffee, beverage, and refreshment products and gives them the authority to redesign the generic item compositions to best serve their taste and health conditions.

### BRIEF DESCRIPTION OF THE DRAWINGS

The present invention and its multiple projections may be better understood by referring to the drawings.

FIG. 1 is an example of an introduction screen and linguistic choices a menu of the first embodiment may comprise.

FIG. 2 is an example of list of varieties of services that a business may provide.

FIG. 3 is an example of available list of food items constructed in the menu system.

FIG. 4 is an example of available list of coffee related varieties the coffee-shop section of a business may provide.

FIG. 5 is an example of related refreshments constructed in the menu system of such a business.

FIG. 6 is an example of alcohol related list of beverages constructed in the menu system.

FIG. 7 is an example of pastry varieties a business may prepare for customers.

FIGS. 8-9 display the flowchart dictating programming terms of the electronic menu system provided in this invention.

### DETAILED DESCRIPTION

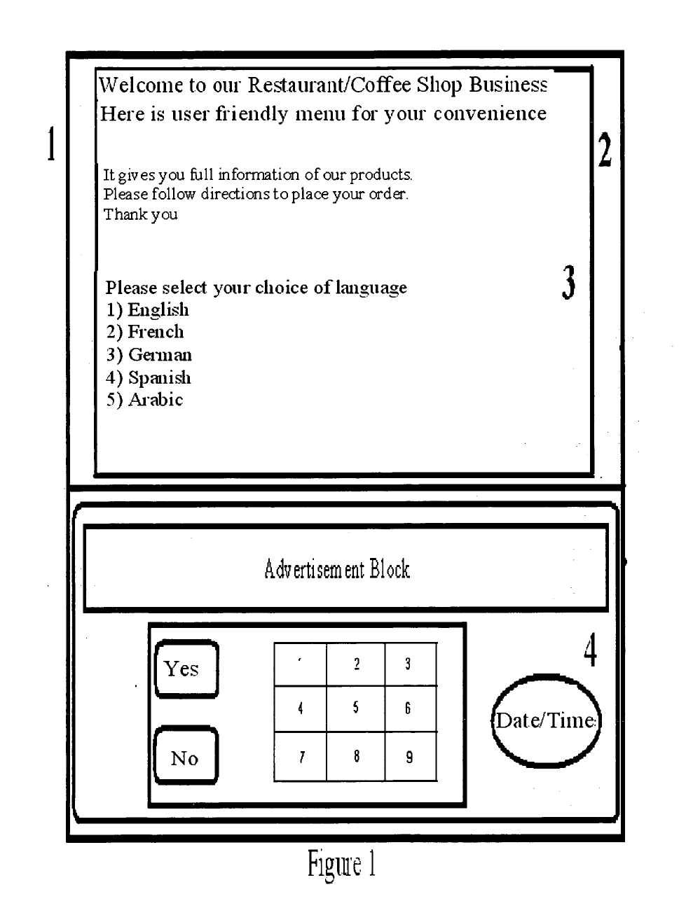

In FIG. 1, the menu system (1) has a frame (2) mechanically supporting input section (4) and output and information section (3). The output section is Liquid Crystal based conventional or flat screen and the input section could be one of touch screen, input buttons, keyboard, and mouse oriented input structure. The input and information sections can exchange positions or can be configured to be in a single window. A block is provided between the information and the input section of the structure. This block is used for any business interested in using the menu system to advertise their products. Although the block is shown at a specific area in the menu, it can be located anywhere in the system in vertical, horizontal or diagonal orientation.

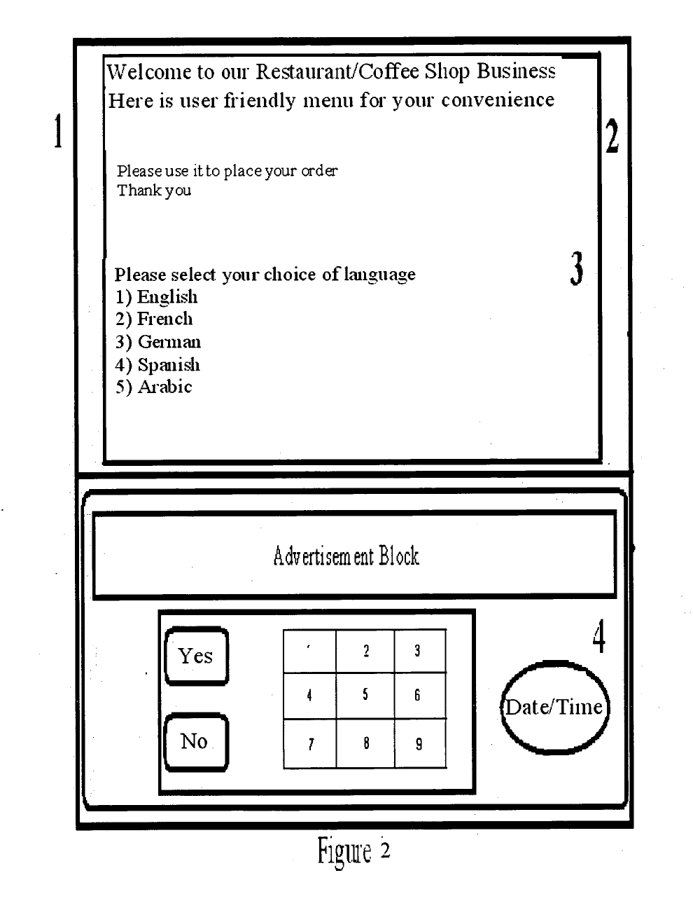

The menu introduces the business type to customers and asks them about their language of preference to continue participation after displays guidelines as to how to use the system. Upon input by customers, the system starts providing communication by their choice of language. Five languages are shown here as an example although the scope of languages that can be used in this system is unlimited depending on the circumstance and geographic location. Once a language of preference is selected, control moves to FIG. 2 where it asks customers for their specific area of interest within the capacity of an ideal business. In this case, there are five alternative business branches customers can access into.

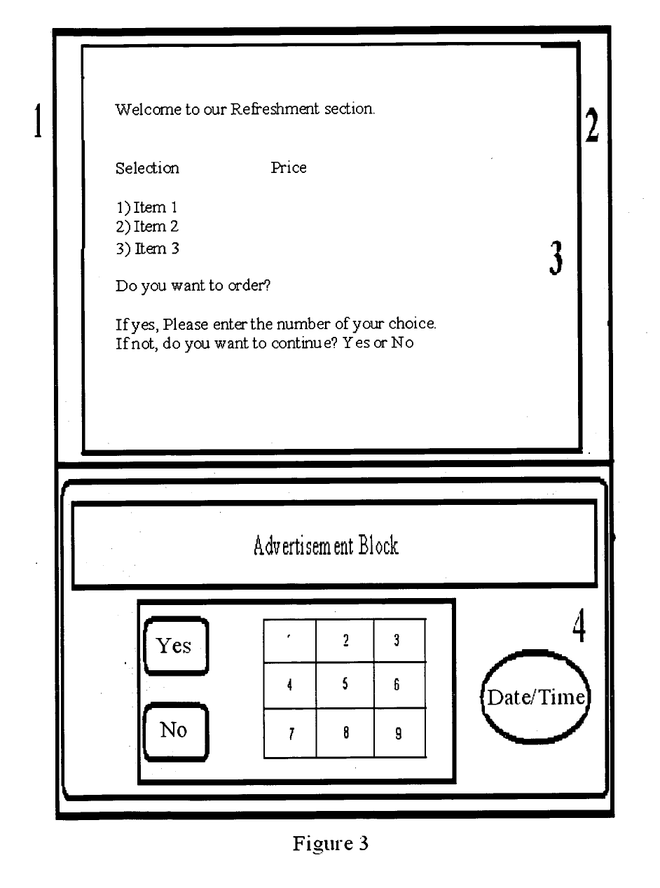

FIG. 3 is a customer accessible menu to select their food of interest in a restaurant business. All types of food varieties available in a related business appear in the screen. Food classification may include, for example, vegetarian dishes, conventional, local and international main and side dishes, etc. Once a specific food item is selected, control shifts to details of that specific item in the screen. Here, it is capable of providing detailed information about the main dish and its side dishes including cooking styles, used spices, and associated components such as dressings, sauces and the price and the time it takes to prepare the composite dish in its generic form. It also gives customers the possibility of adding and/or deleting specific spice/s and other ingredients from the related list relevant to their order/s to fit their taste and/or health requirements. In such a scenario, the system has adaptive capacity that adjusts to modifications and presents a reconfigured bill taking the modification into consideration. The system asks customers if they want to place an order. If they answer affirmatively, an order is memorized in the memory. Customers are then asked if they want to further continue surfing the menu. If the answer is “yes” control takes the customers back to the menu portion in FIG. 2 in order for them to pick another brunch of the business. If the answer is negative, the system thanks the customers and places the order in the system for the assigned server to take it from there.

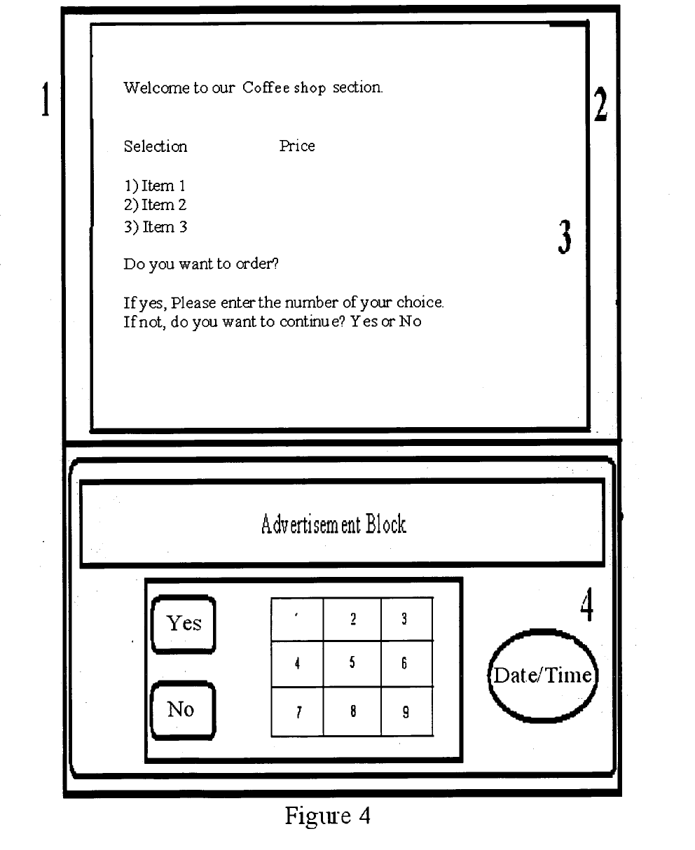

FIG. 4 shows the coffee-shop items available in the business. The process of selecting and placing an order is similar to what so far has been explained in relation to food items. However, customers have the choice to enjoy their coffee items before or after food service. This avoids the process of ordering things at different times and the result tremendously saves time in favor of customer satisfaction.

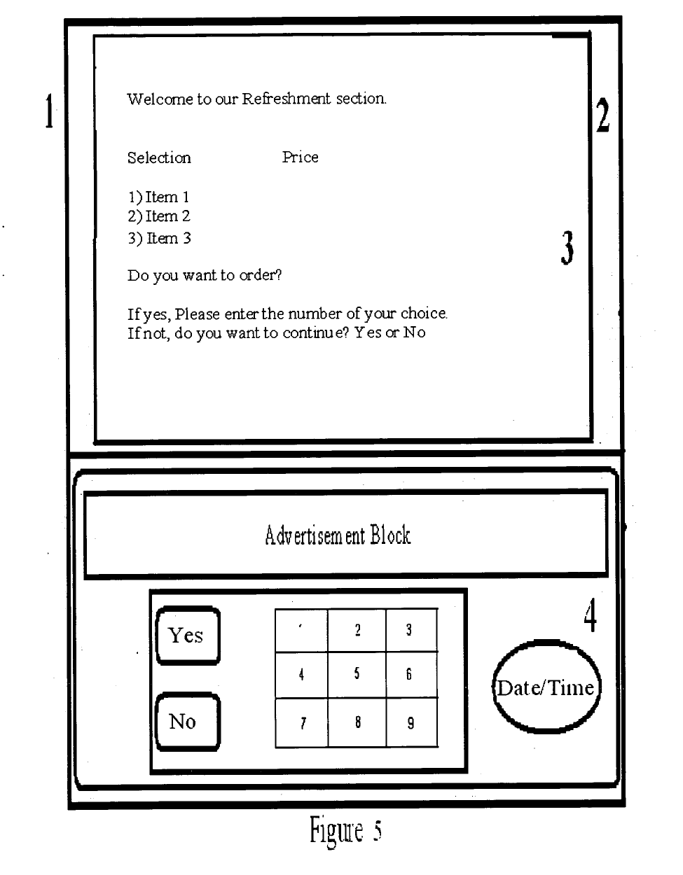

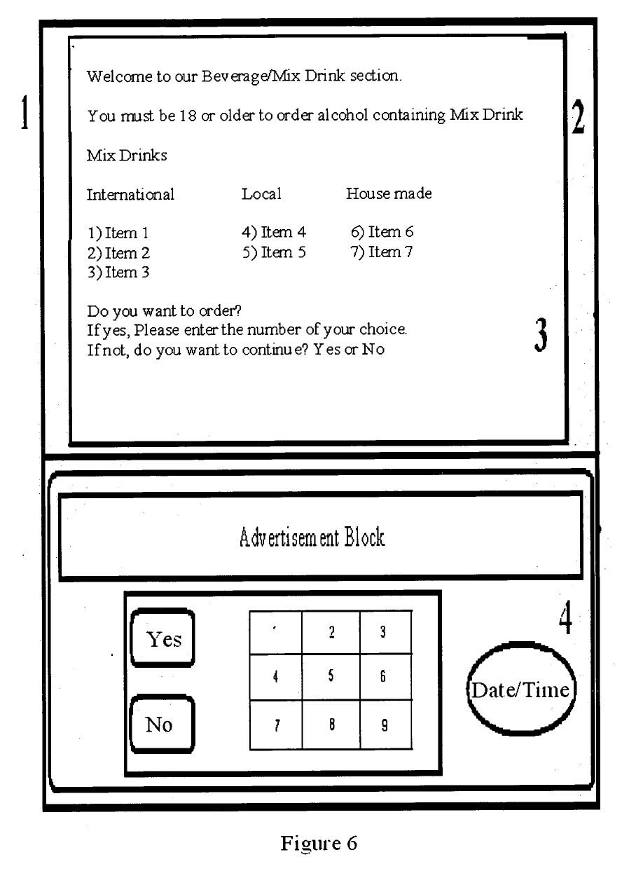

Similar to the first two, the refreshment menu in FIG. 5 and the mix drinks menu in FIG. 6, process customer service in relation to their refreshment and alcohol related beverage choices. Selected item information is provided in the screen including its chemical composition. In the going, customers learn about exactly what they consume. One of the flexibilities provided to customers here is to exclude product/s from the list of particular mix drink composition in accordance with their health-oriented obligations.

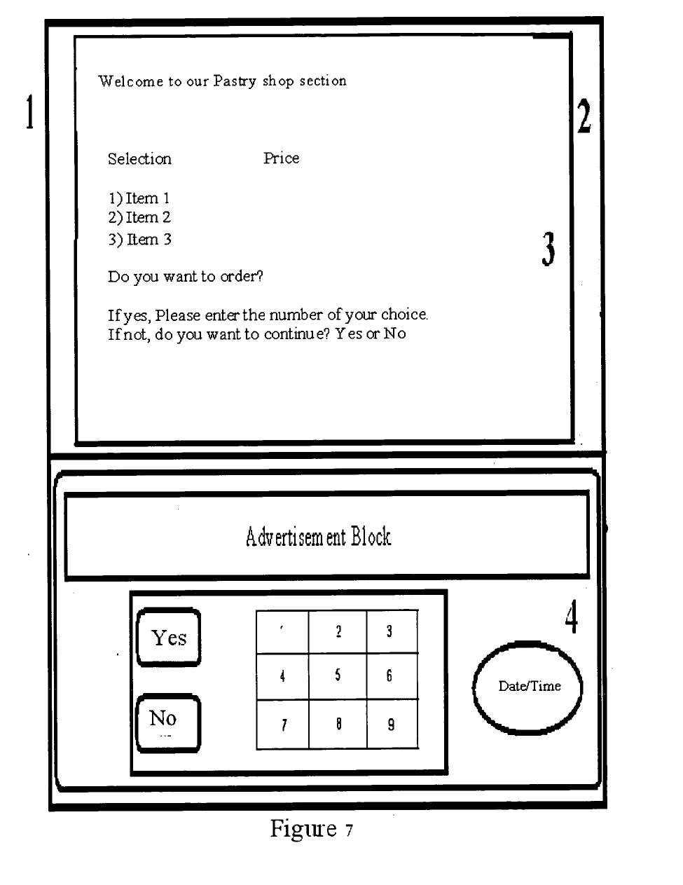

FIG. 7 shows available pastry varieties a given business may prepare and provides complete information about what customers may select to consume including the content of sugar concentration and any other relevant issues associated with it.

After multiple orders from different branches are selected, control summarizes and displays the composite selection in the menu screen, thereby giving customers the chance to modify selections by directly deleting products from and/or adding products into. Then the system asks for customer approval after which an order is placed in the menu system for that particular table.

Graphic displays of refreshments and beverages may not be as important as in the situation of food, coffee and pastry items of the business. Descriptive information may only be enough to provide full customer awareness in this regard. Therefore, the graphic aspect of these items is optional and may not be necessary, although the capacity exists for business management to decide on.

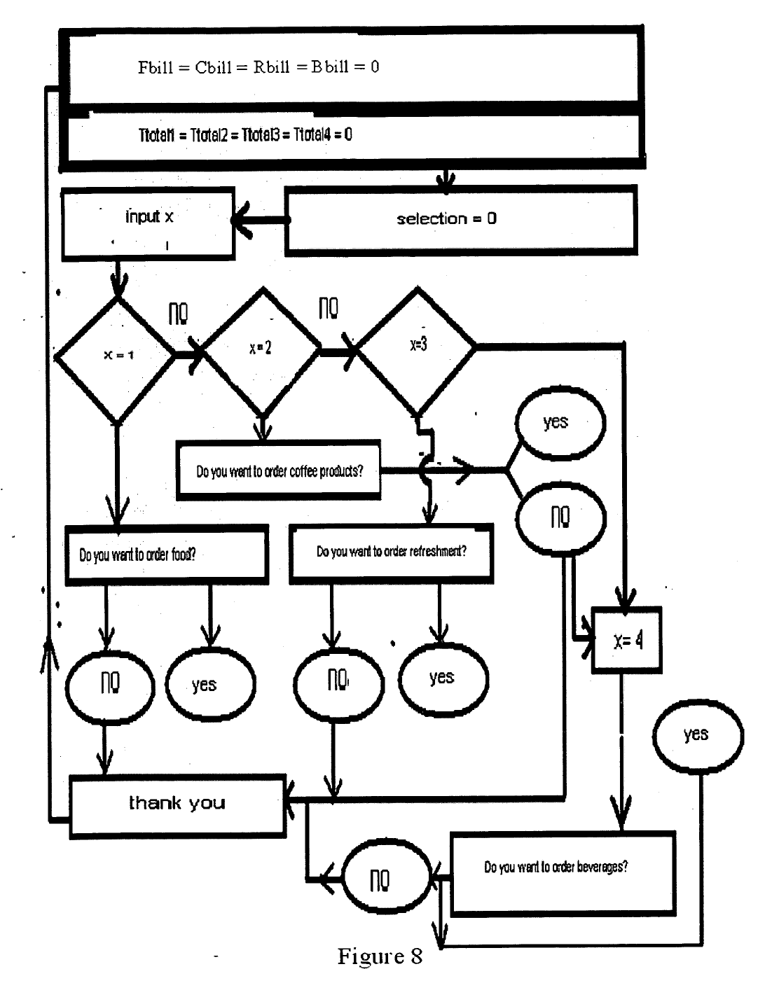

FIG. 8 displays the flow chart stages associated with the software development of the product. Upon input “x”, “x” being from 1-4, a customer may access food menu, coffee menu, refreshments menu and beverages menu and place orders from the menus by directly interacting with the system.

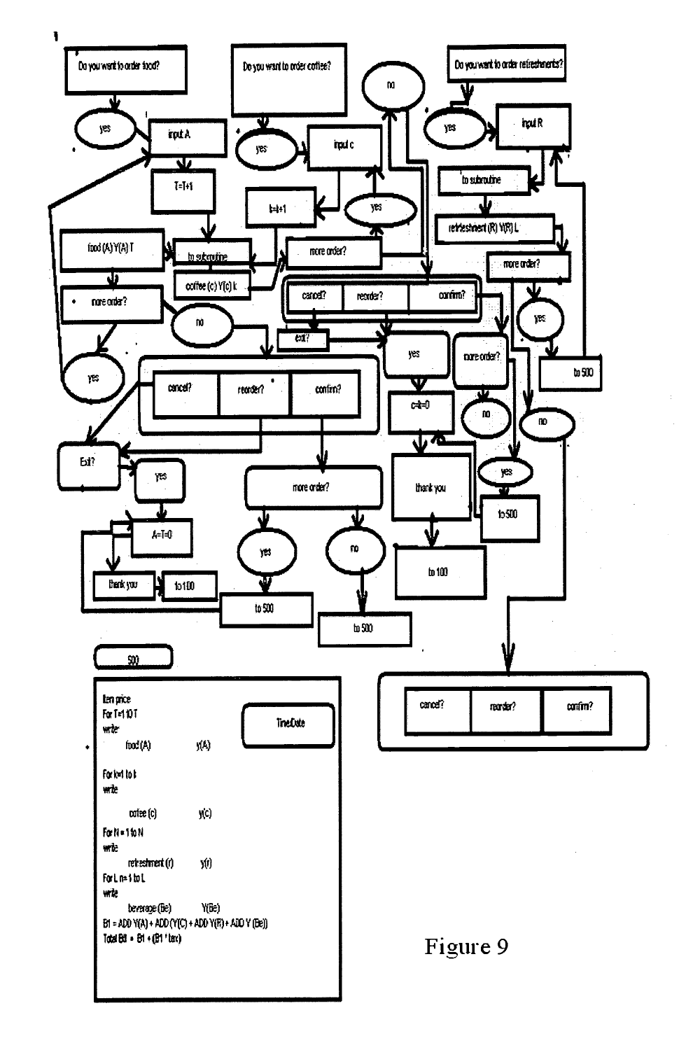

FIG. 9 discloses the steps taken for an order or orders to be placed by customers. A subroutine contains a list of all food, coffee, refreshment and beverage items and their prices. This subroutine is designed to be common to any business product in the departments. A customer may select food menu, for example and access it to place an order. Control then shifts to the subroutine to register the selected item and comes back to ask the customer for more order to place. If the answer is yes, the selection routine continues and the subroutine approached for every order and associated price to appear in the final bill of the customer. If the answer is “no”, however, the system provides the customer with three distinct choices: to cancel a placed order, to reorder, or to confirm the already placed order. Should one of the first two choices is selected; control resets counters and allows the customer to start processing the system anew all the way from the scratch. Should the order is confirmed, however, control goes to a billing table where each order is itemized and the associated price provided, the prices added and tax included there for a total bill. The process continues similarly for each item in each menu system.

The menu can extend to include many other features with in the scope with slight modifications. One feature may be allowing customers to mix their own refreshment and alcohol related drinks and to design for themselves the composition percentage of products in the mix drink.

Another feature could be providing customers with the ability of processing Credit Card or Debit Card based billing at the end of their consumption. And yet, another feature may be giving customers the chance to comment and suggest opinions concerning quality of service and products in the screen based on their experiences.

Another feature to accommodate the blind could also be part of the overall structure by providing means of communication either by using brail or built in sound system.

Another feature may include a scenario where the menu system is installed on restaurant/bar tables for customers to do all of the functions discussed above from.

We claim:

1) A multi-lingual interactive computerized food and beverage menu system that replaces conventional paper menus comprising a frame that supports an input section and an output section, thereby allowing customers to place orders from list of food items, coffee products, refreshment and alcoholic beverages of a relevant business, the system capable of graphically displaying multiple images of selected items in the input section in response to customer input.

2) The input section in the menu system of claim 1, comprising one of touch screen, input buttons, keyboard and mouse element, and the output section comprising one of conventional liquid Crystal display screen and flat screen.

3) The menu system in claim 1 providing customers the capacity to modify selected items by deleting and/or adding ingredients, such as spices and sauces associated with main and side dishes of selected food items from a list of food products.

4) The menu system in claim 1 providing customers the capacity to modify selected items by deleting and/or adding products from a list of mix drink choices and beverages.

5) The menu system in claim 1 proving customers the capacity to process their bills using Credit Cards or Debit Cards and to input comments, opinions and suggestions based on their experience in the business.

6) The menu system in claim 1 having the capacity of calculating itemized bills as orders are made, and further having the capacity to adjust and reconfigure bills based on order modifications, cancellations and changes and presenting the final bill for customers to pay in their choice of payment means.

7) A dynamic software package supporting the menu system in claim 1.

8) Said software package in claim 7 capable of allowing customers to prepare or modify their mix drinks from available business products ingredients and to independently and interactively cancel, reorder, and/or confirm their selections.

9) The menu system in claim 2 provided in restaurant and bar tables.
